(19) United States
(12) Patent Application Publication
(10) Pub. No.: US 2001/0039682 A1
(43) Pub. Date: Nov. 15, 2001

(54) Tool

(76) Inventor: James Bruce Stuart-Smith, Cheltenham (GB)

Correspondence Address: JAMES B STUART-SMITH, REDINGTON, DOURO ROAD, CHELTENHAM, GL50 2PF, GB

(21) Appl. No.: 09/824,686

(22) Filed: Apr. 4, 2001

(30) Foreign Application Priority Data
May 4, 2000 (GB) 0008206.5

(51) Int. Cl. B26B 11/00

(52) U.S. Cl. 7/118

(57) ABSTRACT

A tool module comprises an elongate carrying plate, an axle located with respect to the carrying plate towards one end of the said plate and a tool blade rotatable around the axle to move from a stowed position to a use position. The said tool module is adapted to be fixed together with a plurality of other such modules in a variety of configurations by means of a fixing device or devices passing axially through the respective axles of the modules thereby to form a penknife or multitool.

The present invention relates to tools. More particularly it relates to knives in penknives and multitools.

The penknife, comprising a foldaway blade together with several other useful fold-away implements, such as a corkscrew, scissors and a tool to get stones out of horses'hooves, has been around for many years. More recently there has been introduced the multitool. This is a somewhat sturdier item than a penknife but again comprises an array of tools that fold, or sometimes slide, out of a handle to which they are attached. Typical tools in a multitool might include pliers, screwdrivers and a saw, together, usually, with a knife blade.

All such tools are designed to be as compact as possible while at the same time allowing a versatile range of functions. However, a problem arises in that the different requirements of different users require either that a vast range of different penknives and multitools to be offered by the manufacturer or that most tools include some functions not required by some of the users.

According to the present invention there is provided a tool module comprising an elongate carrying plate, an axle located with respect to the carrying plate towards one end of the said plate and a tool blade rotatable around the axle to move from a stowed position to a use position, wherein the said tool module is adapted to be fixed together with a plurality of other such modules in a variety of configurations by means of a fixing device or devices passing axially through the respective axles of the modules thereby to form a penknife or multitool.

Preferably the fixing device is a threaded fastener.

Preferably the module is adapted to be fixable together with other modules either with their respective axles aligned or with the axle of one module adjacent the non-axle end of the carrying plate of a neighbouring module.

According to a further aspect of the present invention there is provided a penknife or multitool comprising a stack of tools each including an elongate carrying plate, an axle located with respect to the carrying plate towards one end of the said plate and a tool blade foldable around a first common axle from a stowed position to a position ready for use, wherein each of the said tools is a modular item which can be removed from or added to the stack, the stack being fixed together in use by a fixing device passing axially through the said common axle.

Preferably the penknife or multitool includes a second axle around which further tool blades fold, wherein each of the said tools is a modular item that can be fitted either to fold around the first or the second axle.

According to a further aspect of the present invention there is provided a plurality of tool modules, each module comprising a carrying plate and a tool blade mounted on the carrying plate and foldable about an axle between a stowed position and a position ready for use, wherein several of the said tool modules can be fixed together by means of a fixing device passing through their respective axles in a variety of configurations by a user to form a multitool or penknife.

The invention will now be further described with reference to the accompanying drawings in which:

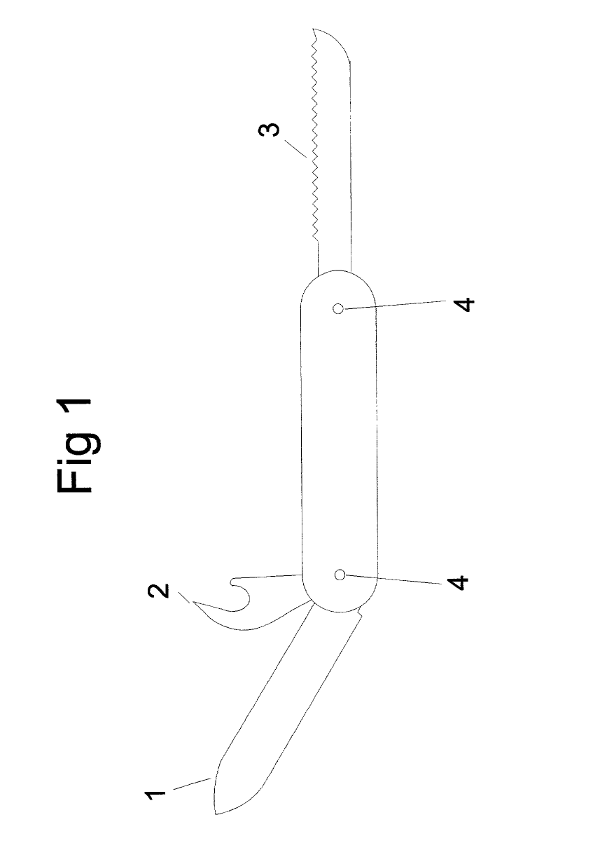

FIG. 1 shows an existing penknife

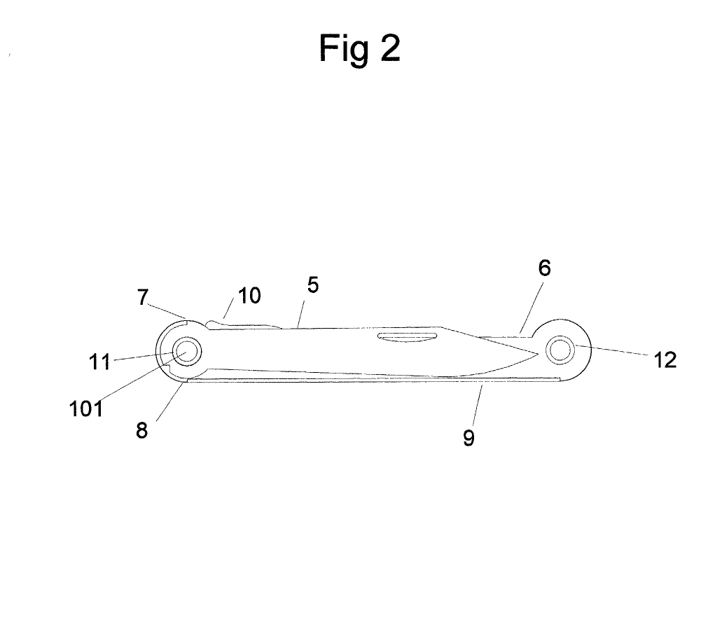

FIG. 2 shows a tool module embodying an aspect of the invention

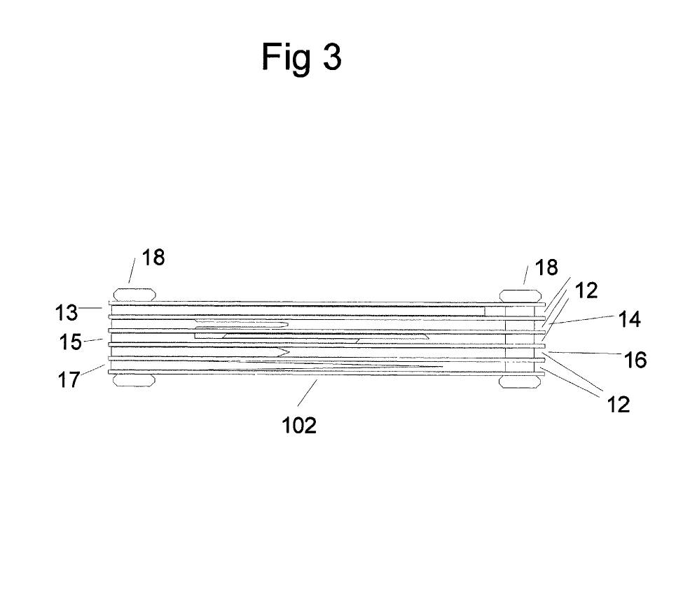

FIG. 3 shows a first embodiment of the invention,

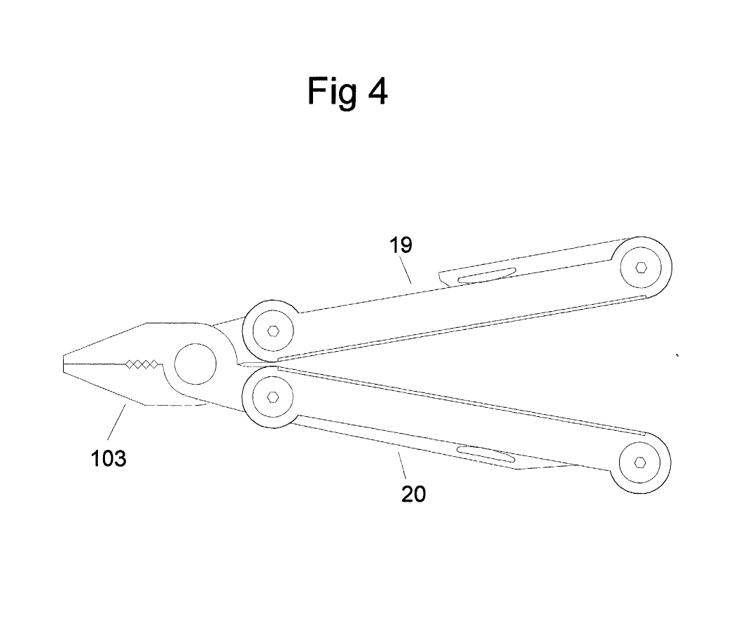

FIG. 4 shows a second embodiment of the invention,

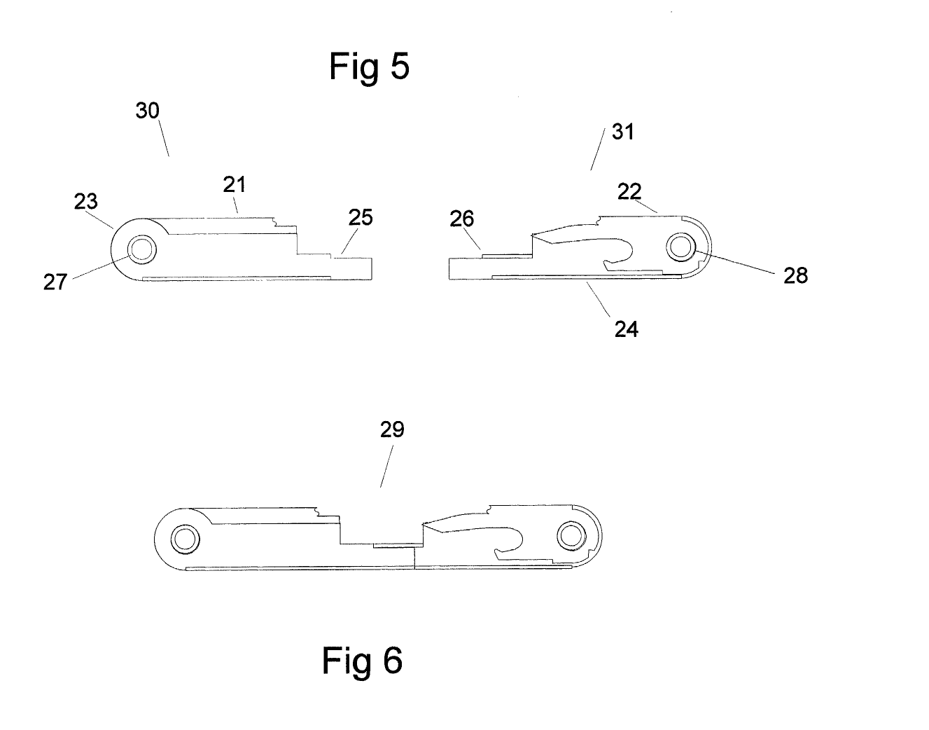

FIG. 5 shows a further embodiment of the invention,

FIG. 6 shows a further embodiment of the invention

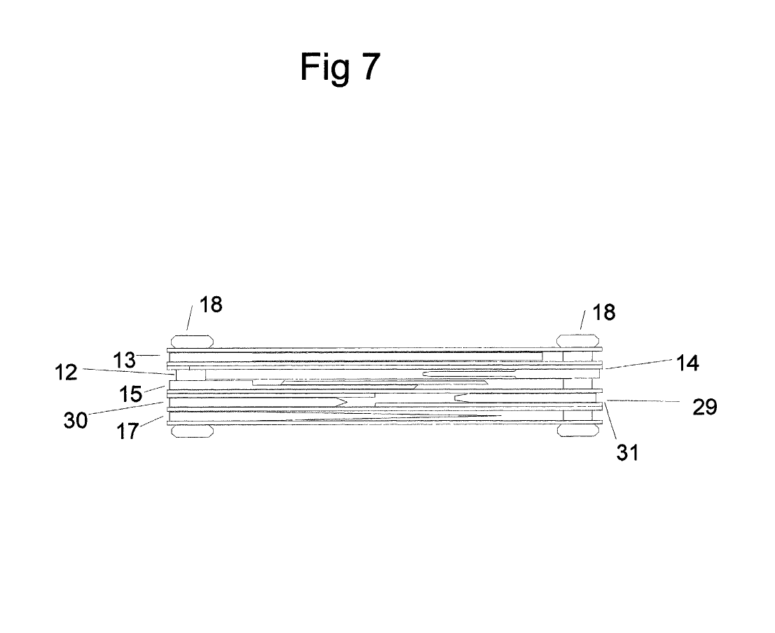

FIG. 7 shows a further embodiment of the invention and

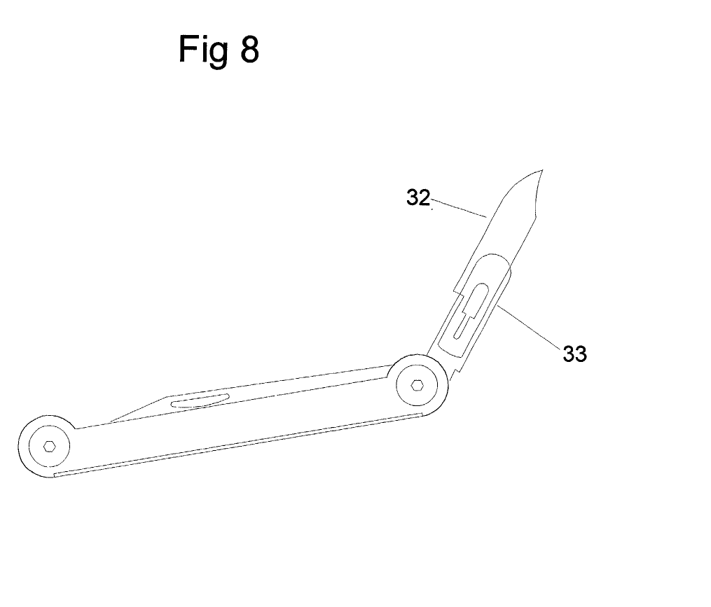

FIG. 8 shows a tool module.

FIG. 1 shows an existing penknife. In this penknife, a number of tools (1, 2, 3) are assembled together to fold around respective common axles. Typically a rivet (4, 4) acts both as the axle around which the tool blades fold and the means of fixing them together. Sometimes the tool blades are separated each from the other by intermediate plates which are also held in place by the rivets. If these rivets are removed, the entire penknife will fall apart into its separate elements of tool blades and interleaving plates.

FIG. 2 shows a tool module embodying an aspect of the invention. The module comprises a tool blade (5), in this case a knife blade, mounted on an elongate carrying plate (6) such that it can fold between a stowed position, shown, and a position ready for use. Other possible tool blades would include almost any possible stowable device, including a bottle opener, a screwdriver, an allen key, a saw, a ruler or even a door key. The blade includes an abutment face (7) that will abut against a corresponding face (8) formed by a folded portion (9) on the carrying plate (6) when the blade (5) is in its use position, to hold it in that position. In the embodiment shown the carrying plate also includes a thumb-operated mechanism (10) to lock the blade in its use position. Alternatively the said folded portion may be arranged to provide a spring detente. In the embodiment shown the blade is mounted to the carrying plate by a flanged axle (11) which is fixed into the carrying plate and drilled axially (101) through its center. At the other end of the carrying plate is a corresponding axially drilled spacer (12).

FIG. 3 shows a stack of tool modules embodying the invention. The several modules (13, 14, 15, 16, 17) are fixed together by means of bolts (18, 18) or similar fixings passing through the respective axially drilled holes. The stack also includes an end-plate (102) at one end to cover the exposed tool blade of the final module (17). The bolts fit the axially drilled holes sufficiently closely to avoid relative movement of the tool modules. The lengths of the respective axles and spacers (12) of the tool modules are such that when the fixings are done up fast the respective tool blades will still be able to fold, without being clamped fast against each other. Further tool modules can be added to the stack using longer bolts, if necessary, to fix them together. The tool modules can also be arranged in different configurations, for example in a different order. In the embodiment shown all the tool modules are faced the same way, with the axle and blade to the left as viewed. However, if preferred the tool can be assembled with some blades to the left and some to the right. An example of this is shown in FIG. 7.

FIG. 4 shows another embodiment of the invention. In this embodiment the said tool modules are assembled to form a pair of stacks (19, 20), which stacks form and incorporate respective handles of a pair of pliers. If desired the pliers may be arranged to stow within the handles in a known manner. As in the previous embodiment, the tool modules may be assembled in either a left- or right-orientation as desired. In different embodiments the plier jaws (103) are replaced by scissors, shears or another pivoting opposed-jaw device.

FIG. 5 shows a pair of tool modules (30, 31) embodying another aspect of the invention. These modules differ from the module of FIG. 2 in that each comprises a shorter tool (21, 22) and backing plate (23, 24) and is provided with complementary mating means (25, 26), rather than a spacer, at the end of the carrying plate opposing the axle (27, 28). The respective mating means (25, 26) allow the pair of tool modules to join together and form a multiple tool unit that can be included in a stack of the modules of FIG. 2. FIG. 6 shows the pair of modules combined to form such a tool unit (29).

FIG. 7 shows a stack including the combined tool unit (29) of FIG. 6. In this stack it will be seen that the tool modules 13, 15 and 17 are in the same orientation as those shown in FIG. 3. Tool module 14, however, has been turned around so that its axle is to the right end as viewed. The spacer 12 of the tool module 14 is now clamped together with the axles of the other tools. The tool unit 29, comprising two tool modules (30, 31), as described above, also fits directly into the stack as shown

FIG. 8 shows another possible tool that may be incorporated in a tool module. Here there is provided a tool module having a cutting blade (12). The blade (32), shown transparent in the drawing, is carried by a blade carrier (33) into which it clips. In use the blade can be detached when it is blunt and replaced with a sharp blade.

1. A tool module comprising an elongate carrying plate, an axle located with respect to the carrying plate towards one end of the said plate and a tool blade rotatable around the axle to move from a stowed position to a use position, characterized in that the said tool module is adapted to be fixed together with a plurality of other such modules in a variety of configurations by means of a fixing device or devices passing axially through the respective axles of the modules thereby to form a penknife or multitool.

2. A tool module as claimed in claim 1, characterized in that the module is adapted to be fixable together with other modules either with their respective axles aligned or with the axle of one module adjacent the non-axle end of the carrying plate of a neighbouring module

3. A tool module as claimed in claim 1, characterized in that the fixing device is a threaded fastener.

4. A tool module as claimed in claim 2, characterized in that the fixing device is a threaded fastener.

5. A tool module as claimed in claim 1, including releasable locking means to hold the said blade in its use position.

6. A tool module as claimed in claim 1, characterized in that the said tool blade is a key for a lock.

7. A tool module as claimed in claim 2, characterized in that the said tool blade is a key for a lock.

8. A penknife or multitool comprising a stack of tools each including an elongate carrying plate, an axle located with respect to the carrying plate towards one end of the said plate and a tool blade foldable around a first common axle from a stowed position to a position ready for use, characterized in that each of the said tools is a modular item which can be removed from or added to the stack, the stack being fixed together in use by a fixing device passing axially through the said common axle.

9. A penknife or multitool as claimed in claim 8 further comprising a second axle around which further tool blades fold, characterized in that each of the said tools is a modular item that can be fitted either to fold around the first or the second axle.

10. A penknife or multitool as claimed in claim 8, characterized in that the said fixing device is a threaded fastener.

11. A penknife or multitool as claimed in claim 9, characterized in that the said fixing device is a threaded fastener.

12. A penknife or multitool as claimed in claim 8, including releasable locking means to lock at least one blade in the said position ready for use.

13. A penknife or multitool as claimed in claim 8 characterized in that one of the said tool blades is a key for a lock.

14. A penknife or multitool as claimed in claim 8 characterized in that the said stack forms all or part of one handle of a pivoting opposed-jaw device.

15. A penknife or multitool as claimed in claim 9 characterized in that the said stack forms all or part of one handle of a pivoting opposed-jaw device.

16. A penknife or multitool as claimed in claim 10 characterized in that the said stack forms all or part of one handle of a pivoting opposed-jaw device.

17. A penknife or multitool as claimed in claim 11 characterized in that the said stack forms all or part of one handle of a pivoting opposed-jaw device.

18. A penknife or multitool as claimed in claim 12 characterized in that the said stack forms all or part of one handle of a pivoting opposed-jaw device.

19. A penknife or multitool as claimed in claim 13 characterized in that the said stack forms all or part of one handle of a pivoting opposed-jaw device.

20. A plurality of tool modules, each module comprising a carrying plate and a tool blade mounted on the carrying plate and foldable about an axle between a stowed position and a position ready for use, characterized in that several of the said tool modules can be fixed together by means of a fixing device passing through their respective axles in a variety of configurations by a user to form a multitool or penknife.
